(19) United States
(12) Patent Application Publication
(10) Pub. No.: US 2012/0198404 A1
(43) Pub. Date: Aug. 2, 2012

(54) DEFECT INSPECTION SUPPORTING APPARATUS AND DEFECT INSPECTION SUPPORTING METHOD

(75) Inventor: Shigeru HASEBE, Oita (JP)

(73) Assignee: KABUSHIKI KAISHA TOSHIBA, Tokyo (JP)

(21) Appl. No.: 13/357,934

(22) Filed: Jan. 25, 2012

(30) Foreign Application Priority Data
Jan. 27, 2011 (JP) 2011-015019

(51) Int. Cl. G06F 17/50

(52) U.S. Cl. 716/112

(57) ABSTRACT

According to one embodiment, layout patterns with defects are grouped based on similarity between the layout patterns, weight values of the groups are set based on formation difficulty of the layout patterns belonging to the groups, the number of defects of the layout pattern belonging to each group is calculated, and rankings of the groups are calculated based on the numbers of defects of the groups and the weight values of the groups.

### CROSS-REFERENCE TO RELATED APPLICATIONS

This application is based upon and claims the benefit of priority from Japanese Patent Application No. 2011-015019, filed on Jan. 27, 2011; the entire contents of which are incorporated herein by reference.

### FIELD

Embodiments described herein relate generally to a defect inspection supporting apparatus and a defect inspection supporting method.

### BACKGROUND

In a semiconductor fabricating process, an inspection is performed in some cases to detect whether there are defects in circuit patterns. The majority of the defects in the circuit patterns are mostly due to dusts rising from the treatment during the process. Moreover, the inspection is also performed to detect systematic pattern defects caused by a slight dimensional trouble of a mask or the like. However, most defects are due to the dusts and the occurrence frequency of the systematic pattern defects is low. Therefore, the systematic pattern defects are often overlooked.

### BRIEF DESCRIPTION OF THE DRAWINGS

FIG. 1 is a block diagram illustrating a general configuration of a system to which a defect inspection supporting method according to a first exemplary embodiment is applied;

FIG. 2 is a block diagram illustrating a hardware configuration of a defect inspection supporting apparatus according to a second exemplary embodiment;

FIG. 3 is a flowchart illustrating a defect inspection supporting method according to a third exemplary embodiment;

FIG. 4 is a plan view illustrating an example of defect-detected portions on a wafer according to the third exemplary embodiment;

FIG. 5 is a diagram illustrating a result obtained by converting defect detection coordinates into the coordinates of design data according to the third exemplary embodiment;

FIG. 6 is a plan view illustrating an extraction example of a layout pattern on design data corresponding to the defect detection coordinates of FIG. 5;

FIG. 7 is a diagram illustrating a grouping result of the layout patterns extracted from the defect detection coordinates;

FIG. 8 is a diagram illustrating a defect frequency in accordance with the number of defects of each group in FIG. 7;

FIG. 9 is a diagram illustrating a defect frequency in accordance with the number of defects of each group and the weight value of each group in FIG. 7;

FIG. 10A is a diagram illustrating an example of a method of weighting groups 1 to 4 in FIG. 8;

FIG. 10B is a diagram illustrating another example of the method of weighting groups 1 to 4 in FIG. 8;

FIG. 10C is a diagram illustrating still another example of the method of weighting groups 1 to 4 in FIG. 8;

FIG. 11A is a plan view illustrating an example of a layout pattern extracted from the first defect-detected coordinates;

FIG. 11B is a plan view illustrating an example of a layout pattern extracted from the second defect-detected coordinates;

FIG. 11C is a plan view illustrating a difference pattern between the layout pattern of FIG. 11A and the layout pattern of FIG. 11B;

FIG. 12A is a plan view illustrating an example of a layout pattern extracted from the third defect-detected coordinates;

FIG. 12B is a plan view illustrating an example of a layout pattern extracted from the fourth defect-detected coordinates;

FIG. 12C is a plan view illustrating a difference pattern between the layout pattern of FIG. 12A and the layout pattern of FIG. 12B;

FIG. 12D is a plan view illustrating the difference pattern when the center coordinates of the layout patterns of FIGS. 12A and 12B are shifted;

FIG. 13A is a plan view illustrating an example of a layout pattern extracted from the fifth defect-detected coordinates;

FIG. 13B is a plan view illustrating an example of a layout pattern extracted from the sixth defect-detected coordinates;

FIG. 13C is a plan view illustrating an example of a layout pattern extracted from the seventh defect-detected coordinates;

FIG. 13D is a plan view illustrating a difference pattern between the layout pattern of FIG. 13A and the layout pattern of FIG. 13B;

FIG. 13E is a plan view illustrating a difference pattern between the layout pattern of FIG. 13A and the layout pattern of FIG. 13C;

FIG. 14A is a plan view illustrating a determination region R1 set in the difference pattern of FIG. 13D;

FIG. 14B is a plan view illustrating the determination region R1 set in the difference pattern of FIG. 13E;

FIG. 14C is a plan view illustrating a method of setting a plurality of determination regions R1 and R2 in the difference pattern;

FIG. 14D is a plan view illustrating a determination region R3 set in the difference pattern of FIG. 13D;

FIG. 14E is a plan view illustrating the determination region R3 set in the difference pattern of FIG. 13E;

FIG. 14F is a plan view illustrating a method of setting a plurality of determination regions R3 to R5 in the difference pattern;

FIG. 15 is a diagram illustrating a method of calculating layout difference values of the difference pattern of FIG. 14C;

FIG. 16 is a diagram illustrating mask dimension error sensitivity values MEF of layout patterns A to C;

FIG. 17 is a diagram illustrating an example of a method of weighting the mask dimension error sensitivity value MEF;

FIG. 18A is a diagram illustrating layout patterns on the design data;

FIG. 18B is a diagram illustrating layout patterns obtained from the layout patterns of FIG. 18A through OPC correction;

FIG. 18C is a diagram illustrating a lithography simulation result of the layout patterns of FIG. 18B; and

FIG. 19 is a diagram illustrating an example of a method of weighting a space distance N of FIG. 18C.

### DETAILED DESCRIPTION

In general, according to one embodiment, a defect inspection supporting apparatus includes a pattern extracting unit, a pattern grouping unit, a weight value setting unit, a defect number calculating unit, and a group ranking calculating unit. The pattern extracting unit is configured to extract layout patterns which correspond to positions on a wafer where the defects are detected. The pattern grouping unit is configured to group the layout patterns based on similarity between the layout patterns extracted by the pattern extracting unit. The weight value setting unit is configured to set weight values of the groups based on formation difficulty of the layout patterns belonging to the groups formed by the pattern grouping unit. The defect number calculating unit is configured to calculate the number of defects of the layout pattern belonging to each group. The group ranking calculating unit is configured to calculate rankings of the groups based on the numbers of defects of the groups and the weight values of the groups.

Hereinafter, a defect inspection supporting apparatus according to exemplary embodiments will be described with reference to the drawings. The invention is not limited to the exemplary embodiments.

### First Exemplary Embodiment

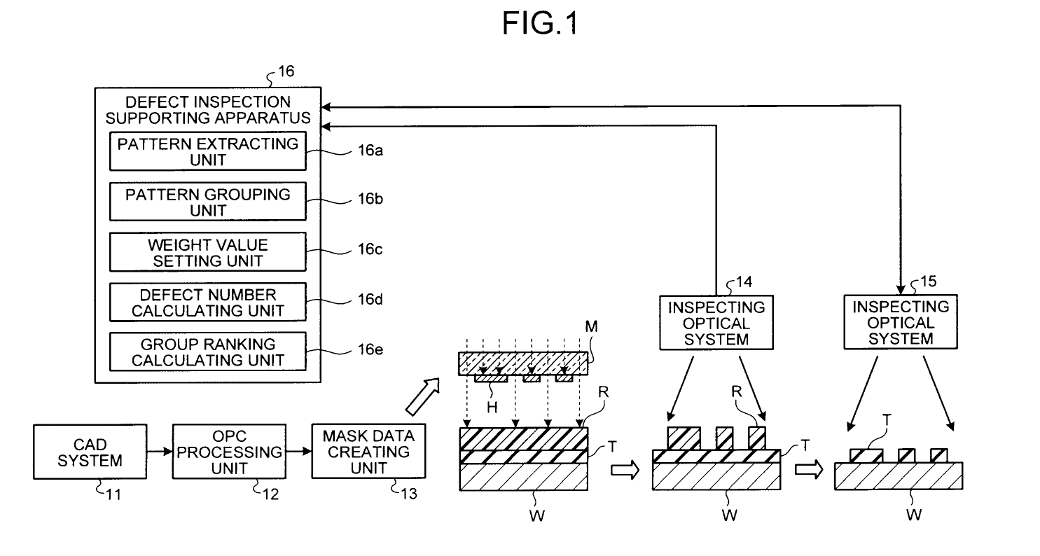

FIG. 1 is a block diagram illustrating a general configuration of a system to which a defect inspection supporting method according to a first exemplary embodiment is applied.

In FIG. 1, a defect inspection supporting device 16 includes a pattern extracting unit 16a, a pattern grouping unit 16b, a weight value setting unit 16c, a defect number calculating unit 16d, and a group ranking calculating unit 16e.

The pattern extracting unit 16a extracts layout patterns corresponding to positions of defects detected on a wafer. The pattern grouping unit 16b groups the layout patterns based on the similarity between the layout patterns extracted by the pattern extracting unit 16a. The weight value setting unit 16c sets the weight value of a group based on the difficulty in forming the layout patterns belonging to the group formed by the pattern grouping unit 16b. The defect number calculating unit 16d calculates the number of defects of the layout patterns belonging to each group. The group ranking calculating unit 16e calculates the rankings of the groups based on the numbers of defects of the groups and the weight values of the groups.

The layout pattern may be design data created using a CAD system, data subjected to a proximity effect correcting process (OPC), or intermediate data created during the proximity effect correcting process (OPC).

The area of a difference pattern, which is formed based on a difference between two layout patterns, may be referred to in order to determine the similarity between the layout patterns.

The weight value may be set depending on a lithography simulation result which is used to verity mask data of the layout pattern, a pattern line width of the design data or the mask data, a pattern pitch, a mask dimension error sensitivity value (a dimension sensitivity on a wafer with respect to a mask dimension irregularity (MEF: mask CD error enhancement factor)), correction or non-correction of a pattern defect detected in manufacturing a mask, a deviation amount from a dimension average value in-plane measurement of the mask when the dimension of the mask is ensured, or a distance from the maximum exposure shot end.

A CAD system 11 is capable of creating design data corresponding to a target layout pattern. An OPC processing unit 12 is capable of performing an optical proximity effect correcting process on a layout pattern specified with the design layout data created by the CAD system 11. A mask data creating unit 13 is capable of creating mask data corresponding to the design layout data subjected to the optical proximity effect correcting process.

Examples of the data format of the design data include text coordinate data, GDS data, oasis data, HSS data, and image data (Tiff, Bit Map, or Jpeg).

An inspecting optical system 14 is capable of imaging a layout pattern transferred to resist films R on a processing layer T. An inspecting optical system 15 is capable of imaging a layout pattern transferred to the processing layer T on a wafer W. In the drawing, the inspecting optical systems 14 and 15 are provided as separate optical systems for convenience. In effect, different inspecting optical systems may not particularly be used to image the layout patterns of the resist films R and the processing layer T. The inspecting optical system may use not only images formed by an optical microscope but also images formed by a scanning electron microscope.

A semiconductor wafer made of, for example, Si may be used as the wafer W. Further, examples of the processing layer T include a multi-crystalline silicon film used for a gate electrode, a resistor, or the like, an Al film or a Cu film used for a wiring, a contact electrode, or the like, and a silicon oxide film or a silicon nitride film used for an insulating layer or the like.

The CAD system 11 creates the design data corresponding to the layout pattern of a semiconductor integrated circuit and transmits the design data to the OPC processing unit 12. Then, the OPC processing unit 12 performs the optical proximity effect correcting process on the layout pattern obtained from the design data created by the CAD system 11 and transmits the processed layout pattern to the mask data creating unit 13. When the OPC processing unit 12 performs the optical proximity effect correcting process, the OPC processing unit 12 can correct the design data such that a dimension difference between the above layout pattern and the layout pattern obtained from the design data is as small as possible when photolithography is performed under the best conditions of the exposure conditions such as the exposure amount or the focus position. When the OPC steps are separated into a lithography step and a processing step, the OPC step is performed in consideration of a processing conversion difference in the processing step. This process is performed to acquire a desired dimension of a resist. Further, in some cases, in the recent optical proximity effect correcting process, the OPC correction may be performed in consideration of not only the best conditions of the exposure amount or the focus position but also the conditions such as an over-exposure or under-exposure amount or a defocus position changed from the focus position.

The mask data creating unit 13 creates the mask data corresponding to the layout pattern subjected to the OPC process. In a photomask M, a mask pattern specified by the mask data created by the mask data creating unit 13 is formed in a light-shielding film H.

On the other hand, a resist film R is formed on the wafer W with the processing layer T interposed therebetween. The resist film R is exposed via the photomask M. Then, the resist film R is patterned by developing the exposed resist film R. In some cases, an anti-reflection film may be applied between the resist film R and the processing layer T in order to prevent light reflected from the processing layer T.

When the resist film R is patterned, a mask pattern formed in the photomask M is transferred to the processing layer T by processing the processing layer T via the resist pattern of the resist film R. For example, a dry or wet etching process may be performed as the process of processing the processing layer T. Thereafter, the resist film R is removed from the processing layer T by a process such as ashing.

When the resist film R is patterned, the inspecting optical system 14 can image the resist pattern of the resist film R. Then, the image of the resist pattern imaged by the inspecting optical system 14 is compared to the image of another region with the same layout pattern between exposure shots, chips, or blocks. When a difference between both images exceeds a preset threshold value, an inspecting apparatus recognizes that there is a defect. When the inspecting apparatus recognizes that there is the defect, the inspecting apparatus can transmit the defect coordinates to the defect inspection supporting apparatus 16.

Alternatively, when the processing layer T is processed, the inspecting optical system 15 can image the pattern transferred to the processing layer T. Then, the image captured by the inspecting optical system 15 is compared to the image of a separate region with the same layout pattern. When a difference between the captured image and the image of the separate region exceeds a preset threshold value, the inspecting apparatus can determine that there is a defect and transmit the defect coordinates to the defect inspection supporting apparatus 16.

Then, the pattern extracting unit 16a extracts the layout pattern where the defect is detected based on the detection coordinates of the wafer recognized to be defective as the comparison and inspection result of the resist pattern image captured by the inspecting optical system 14 or the image of the transfer pattern image captured by the inspecting optical system 15. In the case of a semiconductor apparatus capable of acquiring a plurality of chips at one shot, coordinate conversion needs to be performed once in consideration of an inter-chip pitch dimension to extract the layout pattern. Even when the design data is rotated by 90 degrees, 180 degrees, or 270 degrees, the coordinate conversion needs to be performed in consideration of the rotation angle.

The pattern grouping unit 16b groups the layout patterns based on the similarity between the layout patterns extracted by the pattern extracting unit 16a.

The weight value setting unit 16c sets the weight value of each group based on the formation difficulty of the layout pattern belonging to each group formed by the pattern grouping unit 16b.

The defect number calculating unit 16d calculates the number of defects of the layout pattern belonging to each group formed by the pattern grouping unit 16b.

The group ranking calculating unit 16e calculates the rankings of the groups based on the numbers of defects of the groups and the weight values of the groups.

When the group ranking calculating unit 16e calculates the rankings of the groups, defect-detected portions detected on the wafer and corresponding to the layout patterns belonging to the groups of high rankings are examined with, for example, a scanning electron microscope (SEM) with a high resolution to detect whether an abnormality occurs in the patterns. Further, when there are too many defect-detected portions, in effect, it is difficult to examine all the defects in the patterns on the wafer. Accordingly, the representative detect-detected portion of each group is actually examined. Not only the inspection is performed by the SEM, but also the limited inspection regions are re-inspected by an inspecting apparatus including an electron optical system in some cases. In comparison to an inspecting apparatus using light, an inspecting apparatus using an electron beam can inspect limited inspection regions, although it is difficult to inspect the entire surface of a semiconductor chip due to the fact that defect detection sensitivity is generally high and an inspection time is long.

When it is determined that a process margin can be ensured thanks to pre-determination without a problem with the semiconductor fabrication process as the result of pattern examination of the detect-detected portions detected on the wafer and corresponding to the layout pattern belonging to the group of the high ranking, a circuit pattern can be formed on the wafer W using the photomask M corresponding to the layout pattern, and thus a semiconductor integrated circuit can be manufactured.

Here, the rankings of the groups are calculated based on the number of layout patterns belonging to the groups and the weight values of the groups. Therefore, even when the number of layout patterns belonging to the group is small but there is a fatal defect in the layout pattern belonging to the group, a high ranking can be assigned to the group. Accordingly, even when detecting a defect is easily missed in some cases due to the fact that the defect occurs less frequently and the defect is highly likely to be a fatal defect, it is possible to preferentially examine the defect-detected portion detected on the wafer and corresponding to the layout pattern containing the defect using the SEM or the like. Accordingly, it is possible to improve the detection accuracy of the fatal defect occurring less frequently.

### Second Exemplary Embodiment

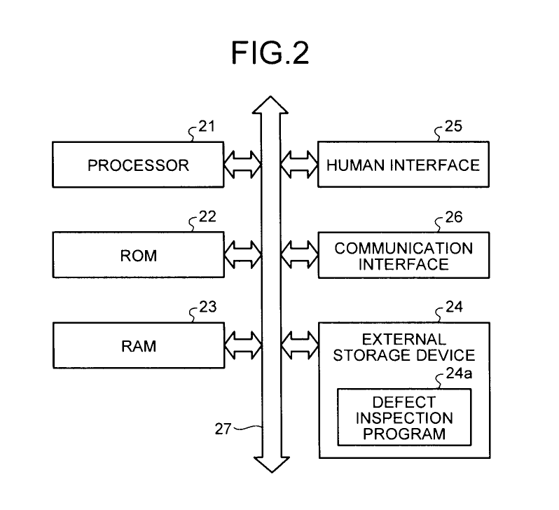

FIG. 2 is a block diagram illustrating the hardware configuration of the defect inspection supporting apparatus according to a second exemplary embodiment.

In FIG. 2, the defect inspection supporting apparatus 16 in FIG. 1 includes a processor 21 that includes a CPU, a ROM 22 that stores fixed data, a RAM 23 that provides a work area or the like to the processor 21, an external storage device 24 that stores a program causing the processor 21 to operate or various kinds of data, a human interface 25 that relays human beings and a computer one another, and a communication interface 26 that provides an outside communication unit. The processor 21, the ROM 22, the RAM 23, the external storage device 24, the human interface 25, and the communication interface 26 are connected to each other via a bus 27.

Examples of the external storage device 24 include a magnetic disk such as a hard disk, an optical disk such as a DVD, and a portable semiconductor storage device such as a USB memory or a memory card. Examples of the human interface 25 include a keyboard, a mouse, and a touch panel serving as an input interface and a display and a printer serving as an output interface. Examples of the communication interface 26 include a LAN card, a modem, and a router configured to be connected to the Internet, a LAN, or the like.

Here, the processor 21 can realize the functions of the pattern extracting unit 16a, the pattern grouping unit 16b, the weight value setting unit 16c, the defect number calculating unit 16d, and the group ranking calculating unit 16e of the defect inspection supporting apparatus 16 in FIG. 1 by executing a defect inspection supporting program 24a. Further, the program executed by the processor 21 may be stored in the external storage device 24 so that the program is loaded to the RAM 23 when the program is executed. Alternatively, the program may be stored in advance in the ROM 22 or may be acquired via the communication interface 26.

### Third Exemplary Embodiment

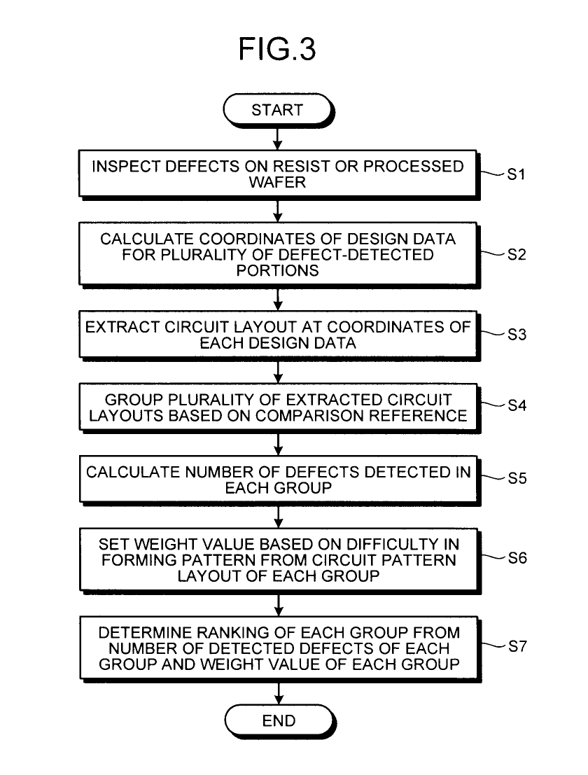

FIG. 3 is a flowchart illustrating a defect inspection supporting method according to a third exemplary embodiment.

In FIG. 3, in step S1, a defect inspecting process is performed on a resist pattern transferred to a resist film on a wafer or a transfer pattern transferred to a processing layer on the wafer. In the defect inspecting process, the same layouts on the design data are compared to each other between shots, chips, circuit blocks, or the like. Specifically, the images captured by the inspecting optical system 14 or 15 in FIG. 1 are compared to each other. When the image difference exceeds the preset threshold value, a defect can be detected. At this time, the number of detected defects may be tens of thousands in some cases. KLA23** and KLA28** manufactured by KLA-Tencor Corporation are examples of the representative wafer defect inspecting apparatus.

Next, in step S2, the coordinates of the design data are calculated for the defect-detected portions detected through the defect inspecting process. The coordinates of the design data can be calculated by matching the coordinates of a pattern formed on the wafer with reference to a specific mark or the like with the coordinates of a pattern on the design data.

Next, in step S3, the layout patterns are extracted at the coordinates of the design data. For example, a range delimited by a few μm in each side can be set as the extraction range of the layout pattern.

Next, in step S4, the layout patterns are grouped based on the similarity between the extracted layout patterns. At this time, the extracted layout patterns can be grouped based on a comparison reference.

Next, in step S5, the number of defects detected from the layout pattern belonging to each group is calculated for each group.

Next, in step S6, the weight value of each group is set based on the formation difficulty of the layout pattern belonging to each group.

Next, in step S7, the rankings of the groups are calculated based on the numbers of defects of the groups and the weight values of the groups.

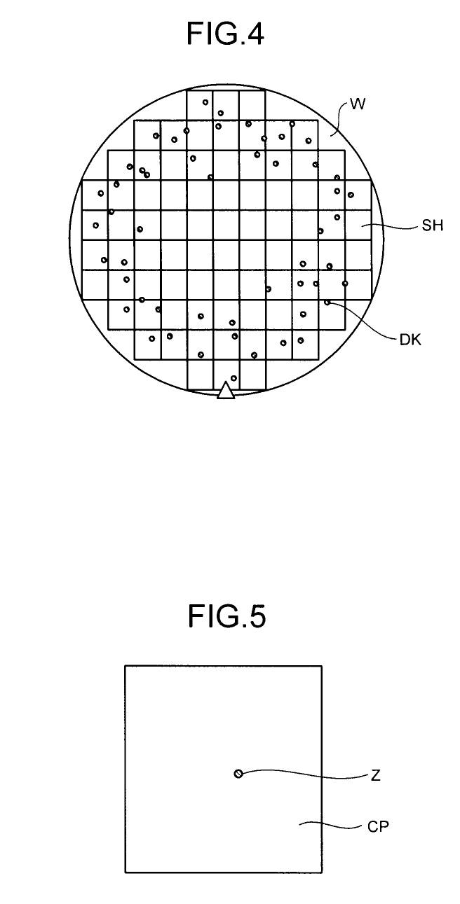

FIG. 4 is a plan view illustrating an example of defect-detected portions on the wafer according to the third exemplary embodiment.

In FIG. 4, each shot region SH is delimited on the wafer W. Further, a defect-detected portion DK appears on the wafer W by performing the defect inspecting process.

Further, some systematic defects on the photomask M may deteriorate a process margin of a lithography process. In particular, when a focus or an exposure amount is changed, a pattern dimension is considerably changed in many cases. For this reason, it is possible to improve detection sensitivity of the systematic defect on the photomask M caused by, for example, deficiency of an OPC accuracy or a pattern dimension manufacture error of the photomask by varying the focus value and the exposure amount at each exposure shot when a resist pattern is formed on the wafer W.

FIG. 5 is a diagram illustrating a result obtained by converting defect-detected coordinates into the coordinates of the design data according to the third exemplary embodiment.

In FIG. 5, a defect-detected location Z is illustrated in a chip CP on the design data by converting the defect-detected portion DK on the wafer W into the defect-detected coordinates. Further, when a plurality of semiconductor chips can be manufactured at one exposure shot, the coordinate conversion needs to be performed in consideration of the pitch dimension or the like between semiconductor chips.

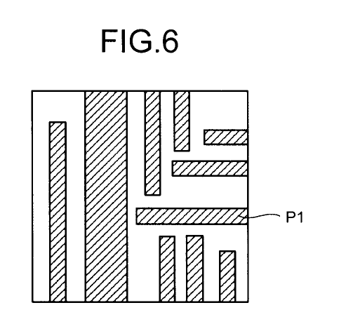

FIG. 6 is a plan view illustrating an extraction example of a layout pattern on the design data corresponding to the defect detection coordinates of FIG. 5.

In FIG. 6, when the defect-detected coordinates corresponding to the design data are calculated, a layout pattern P1 on the design data is extracted. When the layout pattern P1 is extracted, a layout pattern P can be cut which falls within a predetermined range in which the defect-detected coordinates are centered. For example, the range of a square with 0.5 μm to 5 μm in each side can be set as the predetermined range in which the defect-detected coordinates are centered. The extracted layout pattern P1 can be stored in the RAM 23 in FIG. 2.

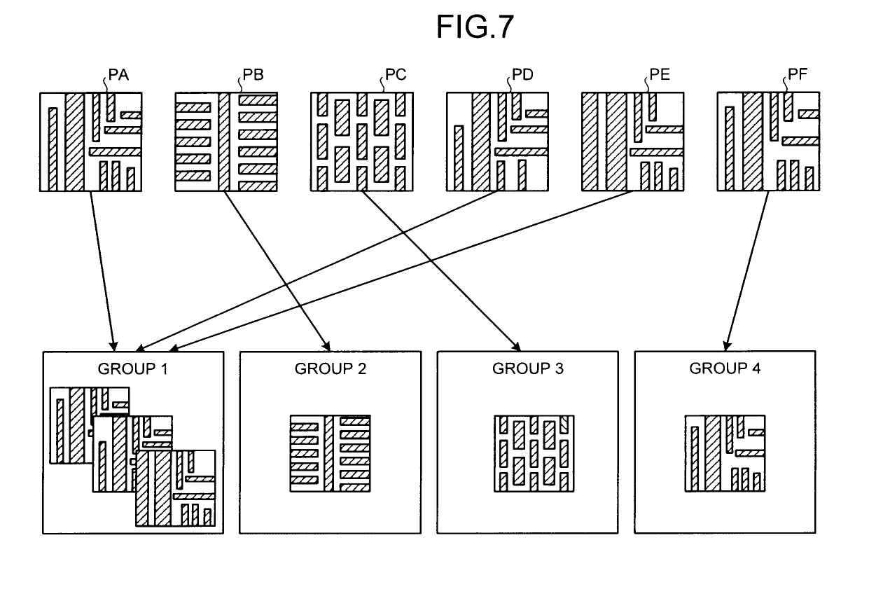

FIG. 7 is a diagram illustrating a grouping result of the layout patterns extracted from the defect detection coordinates.

In FIG. 7, layout patterns PA to PF are extracted from the defect-detected coordinates. When the layout patterns PA to PF are grouped, the layout patterns PA to PC are recognized as separated layout patterns with reference to comparison references, and thus are distributed to groups 1 to 3.

The layout patterns PD and PE are not completely identical with the layout pattern PA. However, since it is determined that the layout patterns PD and PE are similar with the layout pattern PA with reference to the comparison reference, the layout patterns PD and PE are distributed to group 1. The layout pattern PF is partially identical with the layout patterns PA, PD, and PE. However, since the layout pattern PF is determined as a separate layout pattern belonging to group 4 with reference to the comparison reference, the layout pattern PF is distributed to group 4.

In this way, the reason for distributing the similar layout patterns PA, PD, and PE to group 1 is that the defect-detected coordinates of the defect inspecting apparatus contain a position error to some extent. Therefore, if only the completely identical layout patterns are distributed to the same group, there is a high possibility that the completely identical layout patterns are distributed to separate groups due to the position error even in the short state in the completely identical layout patterns.

As the transfer characteristics of a mask pattern, the larger the distance between a pattern and a focus point is, the smaller the dimension influence on a focus point is. Therefore, even when the patterns distant from the outer circumference of the layout pattern, that is, the focus point are different in a layout to some extent, the patterns may be distributed to the same group in some cases. Further, the number of layout patterns to be inspected is reduced by grouping the layout patterns, thereby shortening the inspection time.

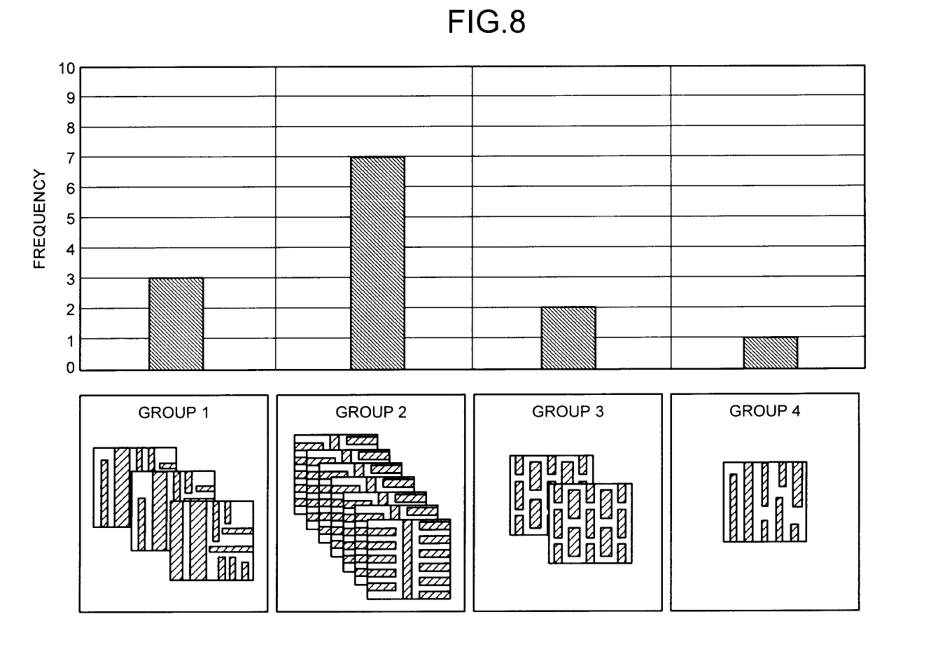

FIG. 8 is a diagram illustrating a defect frequency in accordance with the number of defects of each group in FIG. 7.

In FIG. 8, when the layout patterns PA to PF are classified to groups 1 to 4, the number of defects is calculated for each of groups 1 to 4. The defect frequency in accordance with the number of defects of each of groups 1 to 4 is illustrated as a Pareto diagram.

Only four groups 1 to 4 are illustrated in the example of FIG. 6. Therefore, even when all of the layout patterns PA to PF on the wafer are examined with an SEM, it takes a small time. In effect, since there is a possibility that the number of groups is several tens to tens of thousands, only the layout patterns of the upper groups of the Pareto diagram can be examined due to time constraints.

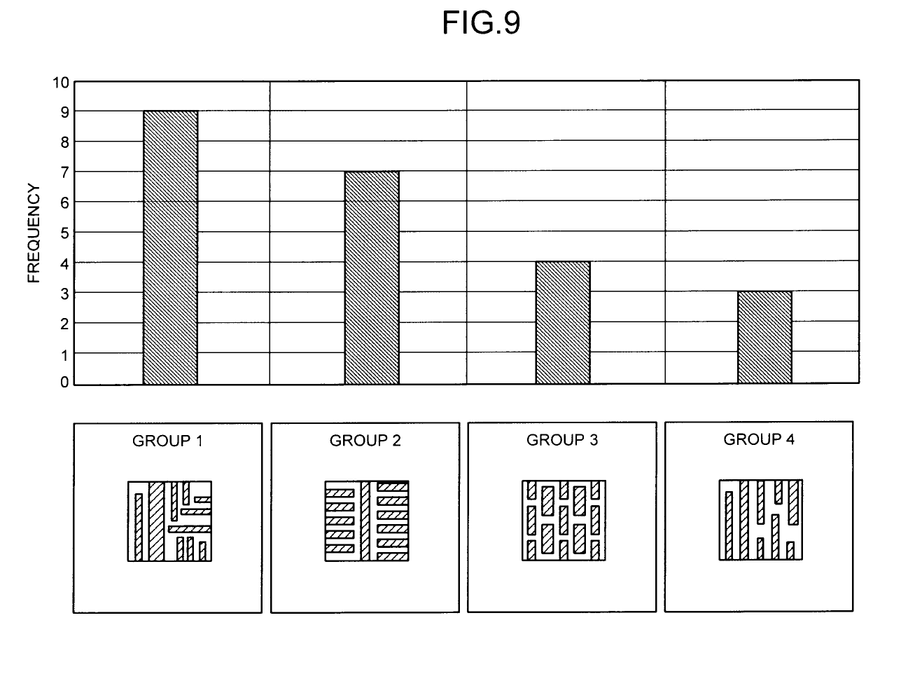

FIG. 9 is a diagram illustrating a defect frequency in accordance with the number of defects of each group and the weight value of each group in FIG. 7.

In FIG. 9, when the layout patterns PA to PF are classified to groups 1 to 4, the weight values are set in accordance with the formation difficulty of the layout patterns PA to PF. Examples of the patterns difficult to be formed include: a pattern that is uncertain when a process is irregular more than a supposed margin in spite of the fact that the minimum necessary margin is ensured in a lithography simulation for verifying the mask data; a pattern that has a pattern line width or a pattern pitch under the condition of the minimum line or the minimum space in a design rule; a pattern with high dimension sensitivity on the wafer to dimension irregularity of a mask; and a pattern with high dimension sensitivity on the wafer to process irregularity. Information regarding the setting of the weight values, for example, the lithography simulation of the above-mentioned mask data, can be calculated in advance using data subjected to the OPC correction. By using graphic processing or the like beforehand or after the extraction of the layout pattern, it can be determined whether the minimum pattern in the design rule is included in the extracted layout pattern.

When it is assumed that it is difficult to form the layout pattern of group 1 in FIG. 8 in comparison to the layout pattern of group 2, the defect frequency of group 1 is larger than that of group 2, and thus the highest ranking is given to group 1 in the Pareto diagram. By preferentially examining the layout pattern belonging to group 1 with the highest ranking in the Pareto diagram, the defect of the layout pattern of group 1 may not be missed even when the occurrence frequency of the defect is lower than that of the layout pattern of group 2.

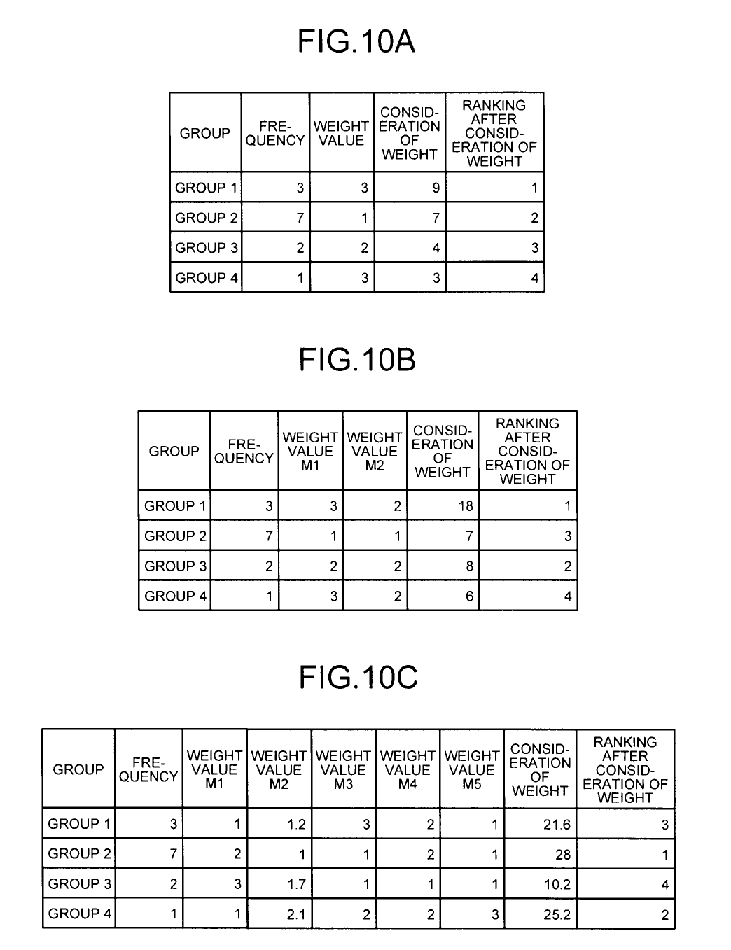

FIG. 10A is a diagram illustrating an example of a method of weighting groups 1 to 4 in FIG. 8. FIG. 10B is a diagram illustrating another example of the method of weighting groups 1 to 4 in FIG. 8. FIG. 10C is a diagram illustrating still another example of the method of weighting groups 1 to 4 in FIG. 8.

In FIG. 10A, it is assumed that the defect frequencies of groups 1 to 4 are 3, 7, 2, and 1, respectively, in accordance with the number of defects. Further, it is assumed that the weight values of groups 1 to 4 are 3, 1, 2, and 3, respectively. When the defect frequencies in accordance with the numbers of defects are multiplied by the weight values, the defect frequencies of groups 1 to 4 are calculated in accordance with the numbers of defects of the groups and the weight values of the groups. As a consequence, rankings 2, 1, 3, and 4 of the groups before the consideration of the weight values are changed are changed to rankings 1, 2, 3, and 4. Accordingly, it is possible to reduce the risk of missing detecting the systematic defect of the mask for which the circuit layout is less frequently used, for example, the defect caused due to deficiency of the OPC accuracy.

A single weight value is considered in the example of FIG. 10A, whereas two weight values M1 and M2 are considered in the example of FIG. 10B. The weight value M1 can be set based on the formation difficulty of the layout pattern, as in FIG. 10A. The weight value M2 can be set based on the use frequency of the layout in a semiconductor circuit. For example, it is examined how many times the layout patterns of groups 1 to 4 in FIG. 6 are used on the design data. Further, for example, when the ratio of the layout patterns of groups 1, 3, and 4 is just 1/2 of the layout patterns of group 2, the weight value M2 can be set to groups 1, 3, and 4.

The formation difficulty of the layout patterns is affected by various items such as the lithography simulation result of the mask data, the minimum dimension of the design rule, the minimum pitch of the design rule, and sensitivity of wafer dimension irregularity with respect to mask dimension irregularity. Therefore, when the formation difficulty of the layout patterns may not be expressed with a single weight value, as illustrated in FIG. 100, a plurality of weight values M1 to M5 may be considered. In this way, it is possible to improve the extraction accuracy of the systematic defect of the mask. However, when too large weight values or too small weight values are set, there is a concern that the extraction accuracy of the systematic defect of the mask may deteriorate. Therefore, appropriate values may be set by analyzing the previous experiment data or the like.

Hereinafter, a method of determining the similarity between the layout patterns will be described in detail.

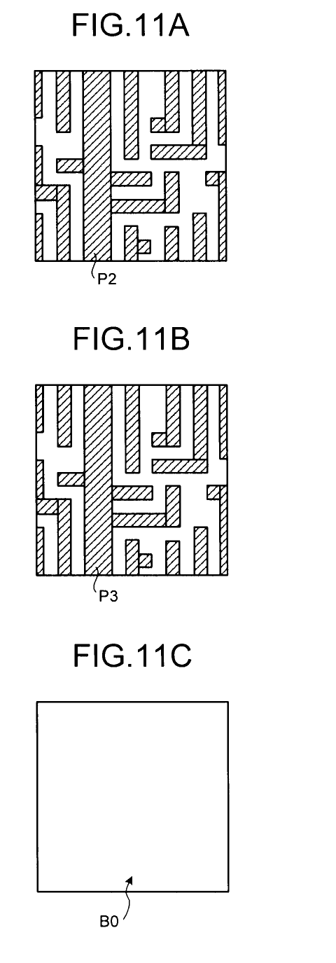

FIG. 11A is a plan view illustrating an example of a layout pattern extracted from first defect-detected coordinates. FIG. 11B is a plan view illustrating an example of a layout pattern extracted from second defect-detected coordinates. FIG. 11C is a plan view illustrating a difference pattern between the layout pattern of FIG. 11A and the layout pattern of FIG. 11B.

In FIGS. 11A and 11B, it is assumed that a layout pattern P2 is extracted from the first defect-detected coordinates on the design data and a layout pattern P3 is extracted from the second defect-detected coordinates on the design data, respectively.

When the similarity between the layout patterns P2 and P3 is determined, a difference pattern B0 between the layout patterns P2 and P3 can be obtained. When the area of the difference pattern B0 is equal to or less than a predetermined value, it can be determined that the layout patterns P2 and P3 are similar with each other. On the other hand, when the area of the difference pattern B0 is greater than the predetermined value, it can be determined that the layout patterns P2 and P3 are not similar with each other. For example, when the layout patterns P2 and P3 are substantially identical with each other, as illustrated in FIG. 11C, no difference pattern B0 is obtained and the area thereof is 0. Accordingly, it can be determined that the layout patterns P2 and P3 are similar with each other.

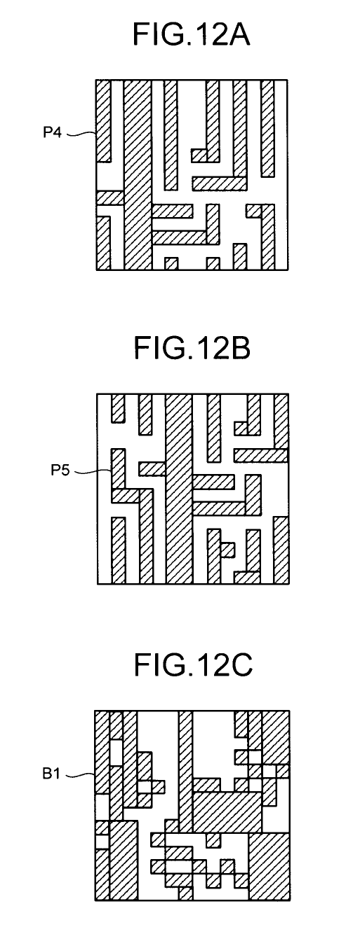

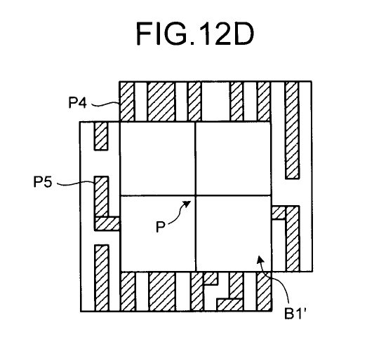

FIG. 12A is a plan view illustrating an example of a layout pattern extracted from third defect-detected coordinates. FIG. 12B is a plan view illustrating an example of a layout pattern extracted from fourth defect-detected coordinates. FIG. 12C is a plan view illustrating a difference pattern between the layout pattern of FIG. 12A and the layout pattern of FIG. 12B. FIG. 12D is a plan view illustrating the difference pattern when the center coordinates of the layout patterns of FIGS. 12A and 12B are shifted.

In FIGS. 12A and 12B, it is assumed that a layout pattern P4 is extracted from the third defect-detected coordinates on the design data and a layout pattern P5 is extracted from the fourth defect-detected coordinates on the design data, respectively.

When a difference pattern B1 between the layout patterns P4 and P5 is obtained, the area of the difference pattern B1 is large, and thus it can be determined that the layout patterns P4 and P5 are not similar with each other.

On the other hand, when the center coordinates of the layout patterns P4 and P5 are shifted and a difference pattern B1′ is then obtained, as illustrated in FIG. 12C, no pattern is generated in the difference pattern B1′. Further, since the area of the difference pattern B1′ is small, it can be determined that the layout patterns P4 and P5 are similar with each other.

That is, when the layout patterns P4 and P5 are similar with each other but the center coordinates of the layout patterns P4 and P5 are displaced, it may be determined that the layout patterns P4 and P5 are not similar with each other in some cases.

In effect, at wafer or exposure shot, distortion occurs with respect to the absolute coordinate reference due to a semiconductor fabricating process, an exposure apparatus, a photomask, and the like. Further, an error is generated to some extent in the calculated defect-detected coordinates in the accuracy limit or the like of a wafer stage of the defect inspecting apparatus itself. Therefore, even when the layout pattern with the substantially identical OPC trouble is detected, an error is generated to some extent in the defect-detected coordinates.

Accordingly, as illustrated in FIG. 12D, center coordinates P may be calculated so that the area of the difference pattern B1′ between the layout patterns P4 and P5 is the minimum, the centers of the layout patterns P4 and P5 may be shifted to the center coordinates P, and then a difference process may be performed.

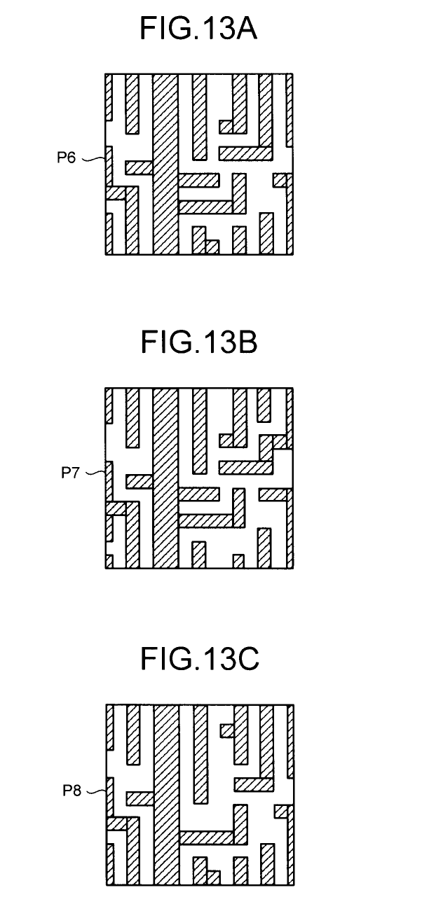

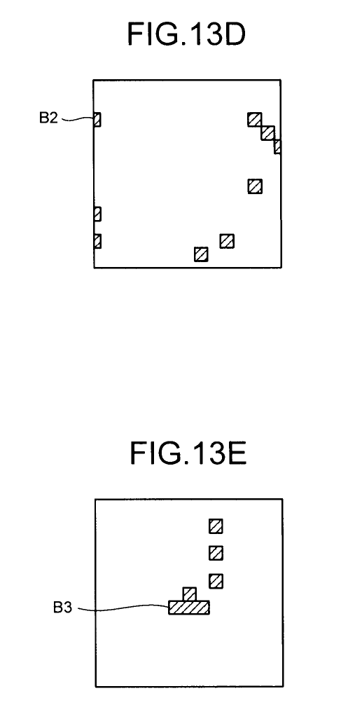

FIG. 13A is a plan view illustrating an example of a layout pattern extracted from fifth defect-detected coordinates. FIG. 13B is a plan view illustrating an example of a layout pattern extracted from sixth defect-detected coordinates. FIG. 13C is a plan view illustrating an example of a layout pattern extracted from seventh defect-detected coordinates. FIG. 13D is a plan view illustrating a difference pattern between the layout pattern of FIG. 13A and the layout pattern of FIG. 13B. FIG. 13E is a plan view illustrating a difference pattern between the layout pattern of FIG. 13A and the layout pattern of FIG. 13C. The coordinate errors in the layout patterns P6 to P8 of FIGS. 13A to 13C are corrected in advance. For example, in the layout of each center portion, there is a certain dimension trouble or a certain OPC trouble on the photomask.

In FIGS. 13A to 13C, it is assumed that a layout pattern P6 is extracted from the fifth defect-detected coordinates on the design data, a layout pattern P7 is extracted from the sixth defect-detected coordinates on the design data, and a layout pattern P8 is extracted from the seventh defect-detected coordinates on the design data.

As illustrated in FIG. 13D, it is assumed that a difference pattern B2 between the layout patterns P6 and P7 is obtained. As illustrated in FIG. 13E, it is assumed that a difference pattern B3 between the layout patterns P6 and P8 is obtained.

In this case, since the layout patterns are not completely identical with other, there are data regarding the difference patterns B2 and B3, and thus the areas of the difference patterns B2 and B3 are not 0. At this time, when the areas of the difference patterns are not 0 and it is determined that the layout patterns are not similar with each other, the number of groups is large. For this reason, there is a concern that detecting a systematic defect may be missed.

In some cases, the mask dimension irregularity or the OPC trouble may cause an open or short-circuited state or dimension abnormality of the circuit pattern transferred to the wafer W in association with the lithography process. In regard to the open or short-circuited state or the dimension abnormality of the circuit pattern, the same dimension abnormality occurs even at a separate region in the short state when the layout environments is highly similar with each other generally in the range of 0 μm to 2.0 μm from an abnormal center layout pattern. Therefore, even when the difference pattern is located at a position distant from the center layout pattern, it may be determined that the original layout patterns are similar with each other, and thus the layout patterns may be classified to the same group.

For example, the difference pattern B2 of FIG. 13D is located at a position distant from the center. Therefore, even when the area of the difference pattern B2 is not 0, it can be determined that the layout patterns P6 and P7 are similar with each other. On the other hand, since the difference pattern B3 of FIG. 13E is located near the center, it can be determined that the layout patterns P7 and P8 are not similar with each other.

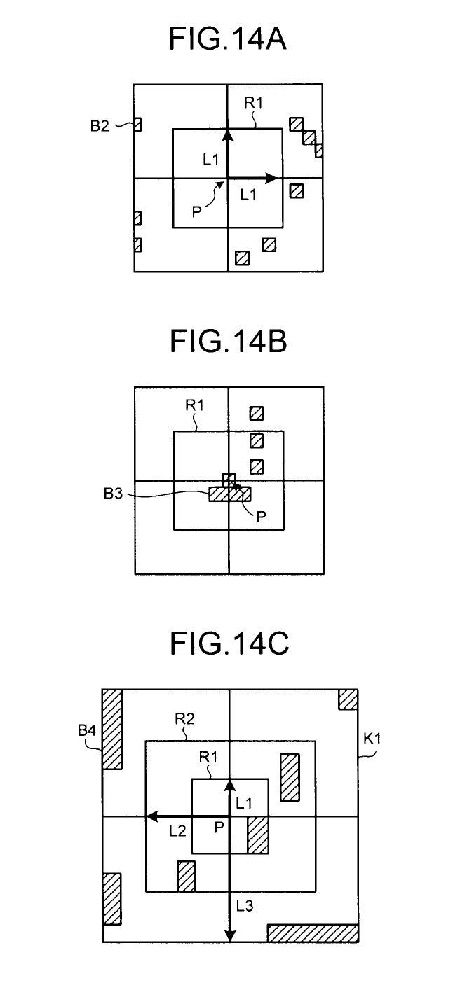

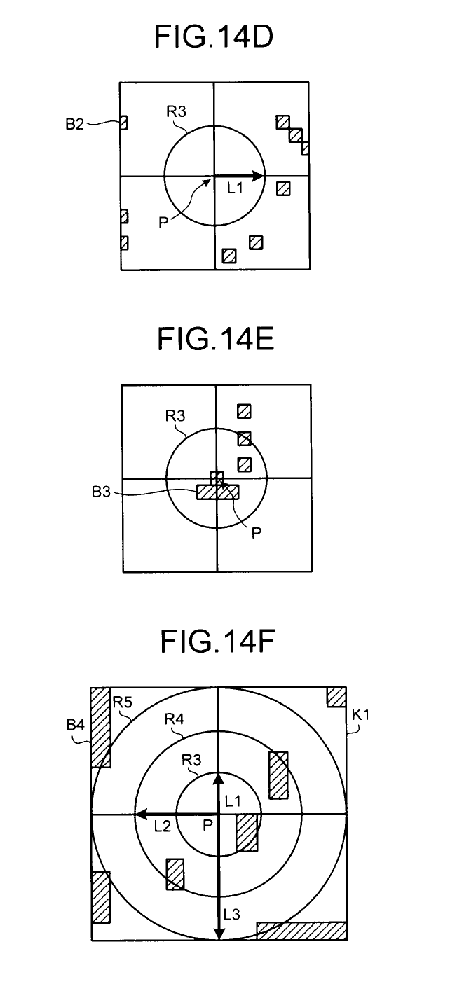

FIG. 14A is a plan view illustrating a determination region R1 set in the difference pattern of FIG. 13D. FIG. 14B is a plan view illustrating the determination region R1 set in the difference pattern of FIG. 13E. FIG. 14C is a plan view illustrating a method of setting a plurality of determination regions R1 and R2 in the difference pattern. FIG. 14D is a plan view illustrating a determination region R3 set in the difference pattern of FIG. 13D. FIG. 14E is a plan view illustrating the determination region R3 set in the difference pattern of FIG. 13E. FIG. 14F is a plan view illustrating a method of setting a plurality of determination regions R3 to R5 in the difference pattern.

In FIGS. 14A to 14C, when the area of the difference pattern B2 is not 0, the determination region R1 can be set in the difference pattern B2 to determine the similarity between the layout patterns P6 and P7. The determination region R1 may have a rectangle in which the distance from the center coordinates P thereof is L1. The distance L1 may be set to 2 μm or more on the principle of the pattern transfer of the lithography process. Here, when the distance L1 is set to about 2 μm, there is a concern that the number of groups is large in consideration of the number of layouts in a semiconductor integrated circuit. For this reason, it is desirable that the distance L1 is set in the range of 0.2 μm to 2.0 μm. At this time, when the distance L1 is set to be too small, there is a concern that the layout patterns originally classified to separate groups may be classified to the same group. For this reason, it is not desirable that the distance L1 is set to 0.2 μm or less.

Since the area of the difference pattern B2 is 0 in the determination region R1, it can be determined that the layout patterns P6 and P7 are similar with each other.

Further, when the area of the difference pattern B3 is not 0, the determination region R1 can be set in the difference pattern B3 to determine the similarity between the layout patterns P7 and P8. Further, since the area of the difference pattern B3 is not 0 in the determination region R1, it can be determined that the layout patterns P6 and P7 are not similar with each other.

Alternatively, when the area of the difference pattern B4 is not 0, the determination regions R1 and R2 having different sizes can be set to be concentric to determine the similarity between the original layout patterns. At this time, when it is assumed that L2 is the distance from the center coordinates P of the determination region R2 and L3 is the distance from the center coordinates P of a cutout region K1 of the layout pattern, it is possible to calculate the areas of the difference pattern B4 of a portion of the distance L1, a portion of a distance L2−L1, a portion of a distance L3−L2. The similarity between the original layout patterns may be determined based on the areas of the difference pattern B4 of the three portions.

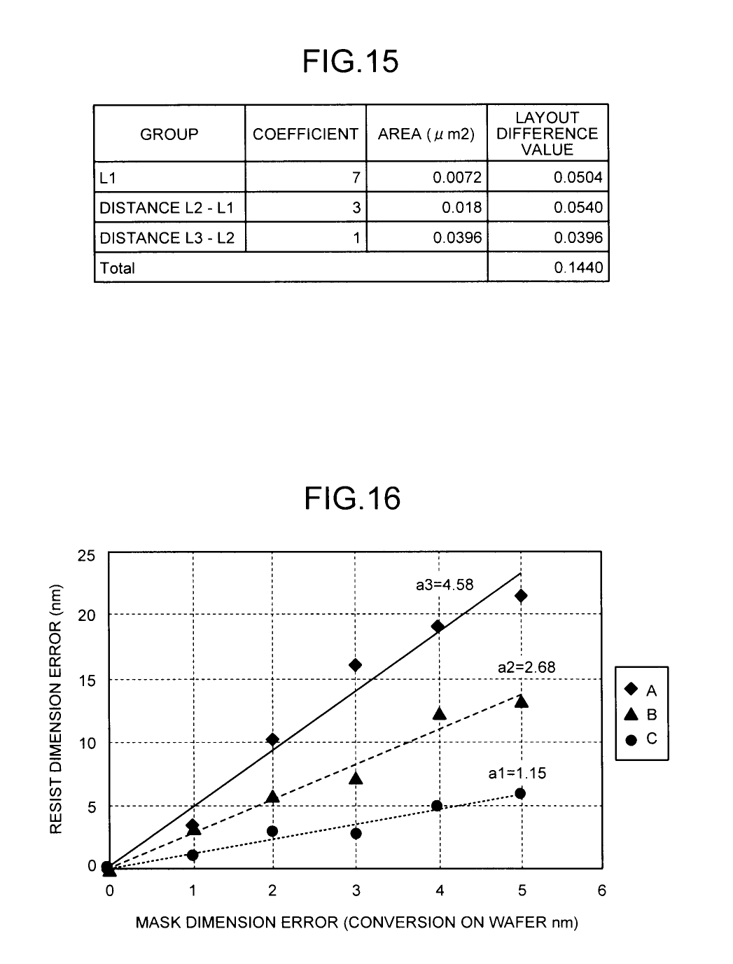

FIG. 15 is a diagram illustrating a method of calculating the layout difference values of the difference pattern of FIG. 14C.

In FIG. 15, it is assumed that the areas are calculated for the difference B4 of the portion of the distance L1, the portion of the distance L2−L1, and the portion of the distance L3−L2. At this time, the coefficient of each portion can be set in consideration of the distance from the center coordinates P. For example, 7 is set as the coefficient of the portion of the distance L1 which is the closest to the center coordinates P, 1 is set as the coefficient of the portion of the distance L3−L2 which is the farthest from the center coordinates P, and 3 is set as the coefficient of the middle portion.

The layout difference value is calculated by multiplying the area of each area by each coefficient. Further, the sum of the layout difference values is 0.1440 μm2. At this time, when the area of the portion of the distance L1 which is the closest to the center coordinates P becomes larger by making the coefficient large, the layout difference value can be made to be large. Further, even when the area of the portion of the distance L3−L2 which is distant from the center coordinates P becomes larger by making the coefficient small, the layout difference value can be made not to be large to that extent. Further, the similarity between the layout patterns can be determined by comparing the sum of the layout difference values to a preset layout difference value reference.

In FIGS. 14A to 14C, the method of setting the rectangular determination regions R1 and R2 has hitherto been described. As illustrated in FIGS. 14D to 14F, however, circular determination regions R3 to R5 may be set instead of the rectangular determination regions R1 and R2.

Hereinafter, the formation difficulty of the layout patterns will be described in detail.

FIG. 16 is a diagram illustrating mask dimension error sensitivity values MEF of layout patterns A to C. The horizontal axis represents a value on the wafer obtained by converting the dimension error of the photomask. For example, in a portion described as 1 nm, the value on the mask indicates that the dimension error corresponding to 4 nm, which is the four times of the value, occurs when it is assumed that a reduction ratio of an exposure apparatus is 1/4. The vertical axis represents a result measured with an SEM or the like by actually transferring the pattern, where the dimension error occurs, to the wafer.

In FIG. 16, the weight value indicating the formation difficulty of the layout pattern is set in accordance with the dimension sensitivity on the wafer. In the MEF evaluation, in effect, it is difficult to search for the pattern in which an appropriate mask dimension error occurs accidently. For this reason, a dimension evaluation pattern layout is first generated, an evaluation pattern group, which is obtained by performing a bias process on the dimension evaluation patterns as the kinds of patterns uniformly by 0.5 nm, 1.0 nm, 1.5 nm, 2.0 nm, and 2.5 nm and dimension edges, is mounted on the photomask, and then the evaluation pattern group is measured on the wafer.

At this time, a slope obtained by calculating a regression straight line, which is a relation between the dimension on the photomask and the dimension on the wafer, is the MEF value. For example, it is supposed that the MEF value of the layout pattern A is 4.58, the MEF value of the layout pattern B is 2.68, and the MEF value of the layout pattern C is 1.15. When the MEF value is large, the dimension error of the photomask is increased to the dimension on the wafer and is transferred. Thus, when a layout pattern with the large MEF value is included, there is a potentially high possibility that dimension abnormality such as an open or short-circuited state occurs. Accordingly, the weight value can be set in accordance with the magnitude of the MEF value.

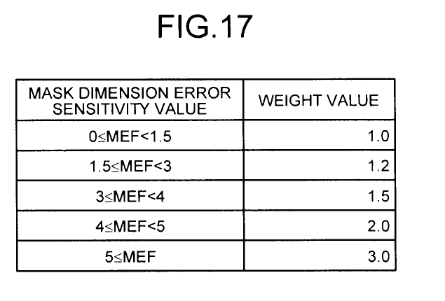

FIG. 17 is a diagram illustrating an example of a method of weighting the mask dimension error sensitivity value MEF.

In FIG. 17, when the MEF value increases, the weight value can be made to be large. Then, the weight value can be determined in accordance with the formation difficulty of the layout pattern.

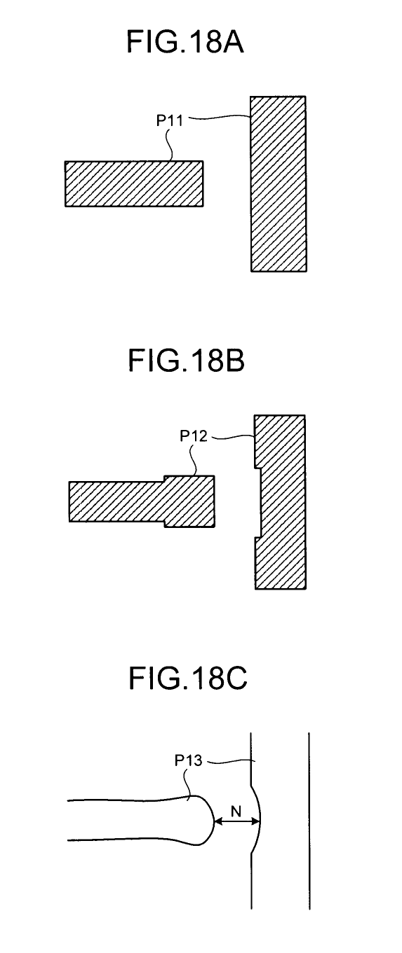

FIG. 18A is a diagram illustrating layout patterns on the design data. FIG. 18B is a diagram illustrating layout patterns obtained from the layout patterns of FIG. 18A through the OPC correction. FIG. 18C is a diagram illustrating a lithography simulation result of the layout patterns of FIG. 18B.

In FIG. 18A, in layout patterns P11, there is a concern that a pattern-shorted state or a pattern shorting state may occur due to the optical proximity effect of the lithography process. For this reason, as illustrated in FIG. 18B, the layout patterns P12 obtained from the layout patterns P11 on the design data of FIG. 18A through the OPC correction are generated in the photomask.

Then, layout patterns P13 subjected to the lithography process can be obtained by executing the lithography simulation on the layout patterns P12. At this time, it is confirmed whether a predetermined specification determined in advance by measuring a space distance N between the layout patterns P13 is interrupted. In a semiconductor mass production step, the mask data is generated without a single layout pattern in which the specification determined in advance by measuring the space distance N is interrupted, and then the photomask is formed. Here, the space distance N may be a potential candidate, when the layout pattern of the specification is present at least. For this reason, the weight value indicating the formation difficulty of the layout pattern can be set in accordance with the space distance N obtained through the lithography simulation.

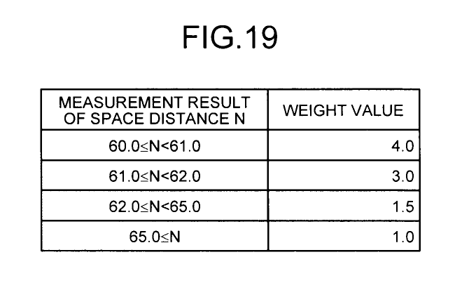

FIG. 19 is a diagram illustrating an example of a method of weighting a space distance N of FIG. 18C.

In FIG. 19, the limit specification of the space distance N is 60 nm. When the space distance N is close to 60 nm, the weight value is set to be large. The weight value can be made to be smaller, as the space distance N increases.

As the method of setting the weight value indicating the formation difficulty of the layout pattern, a pattern is not normally formed due to generation of dusts in the step of forming a mask and the pattern is corrected in some cases, as well as the above-described method. However, substantially normal patterns may be considered in the setting of the weight value, since a considerable influence on the transferred dimension remains in some cases.

When the in-plane uniformity of the mask dimension is measured, it is supposed that a dimension deviation amount is large even after the transfer of the pattern to the wafer in a region where the dimension deviation amount is large with reference to the average value of the measurement value. Therefore, the weight value may be set to be large in the layout pattern extracted from the region where the dimension deviation amount is large with reference to the measurement average value of the mask dimension.

Even in an exposure apparatus, there is a concern that a dimension deviation occurs near the outer circumference of a projection and exposure lens, that is, the corner of the maximum exposure region. Accordingly, the weight value may be set to be large in the layout pattern extracted from this region.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A defect inspection supporting apparatus comprising:
a pattern extracting unit configured to extract layout patterns with defects;
a pattern grouping unit configured to group the layout patterns based on similarity between the layout patterns extracted by the pattern extracting unit;
a weight value setting unit configured to set weight values of the groups based on formation difficulty of the layout patterns belonging to the groups formed by the pattern grouping unit;
a defect number calculating unit configured to calculate the number of defects of the layout pattern belonging to each group; and
a group ranking calculating unit configured to calculate rankings of the groups based on the numbers of defects of the groups and the weight values of the groups.

2. The defect inspection supporting apparatus according to claim 1, wherein the similarity between the layout patterns is determined with reference to an area of a difference pattern indicating a difference between two layout patterns.

3. The defect inspection supporting apparatus according to claim 2, wherein center coordinates are calculated such that an area of the difference pattern is the minimum, centers of the two layout patterns are shifted to the center coordinates, and then a difference process is performed.

4. The defect inspection supporting apparatus according to claim 1, wherein the weight values are set in accordance with a lithography simulation result of mask data of the layout patterns, a pattern line width, a pattern pitch, a mask dimension error sensitivity value, correction or non-correction of a pattern in manufacturing a mask, a deviation amount from a dimension average value in in-plane measurement of the mask when the dimension of the mask is ensured, or a distance from the maximum exposure shot end.

5. The defect inspection supporting apparatus according to claim 1, wherein the group ranking calculating unit calculates the rankings of the groups based on the numbers of layout patterns belonging to the groups, a use frequency of the layout patterns belonging to the groups on design data, and the weight values of the groups.

6. The defect inspection supporting apparatus according to claim 1, wherein the layout pattern is a layout pattern of a semiconductor integrated circuit.

7. The defect inspection supporting apparatus according to claim 1, wherein the extracted layout pattern with the defect is a resist pattern transferred to a resist film on a wafer or a transfer pattern transferred to a processing layer on the wafer.

8. The defect inspection supporting apparatus according to claim 7, wherein the layout pattern with the defect is a pattern in which a difference between a captured image of the resist pattern or the transfer pattern and the layout pattern on the design data exceeds a preset threshold value.

9. The defect inspection supporting apparatus according to claim 1, wherein an extraction range of the layout pattern with the defect is set as a range delimited by a few μm in each side.

10. The defect inspection supporting apparatus according to claim 1, wherein the formation difficulty is determined based on a lithography simulation result of mask data of the layout patterns, a minimum dimension of a design rule, a minimum pitch of the design rule, or sensitivity of wafer dimension irregularity with respect to mask dimension irregularity.

11. A defect inspection supporting method comprising:
extracting layout patterns with defects;
grouping the layout patterns based on similarity between the extracted layout patterns;
setting weight values of the groups based on formation difficulty of the layout patterns belonging to the groups;
calculating the number of defects of the layout pattern belonging to each group; and
calculating rankings of the groups based on the numbers of defects of the groups and the weight values of the groups.

12. The defect inspection supporting method according to claim 11, wherein the similarity between the layout patterns is determined with reference to an area of a difference pattern indicating a difference between two layout patterns.

13. The defect inspection supporting method according to claim 12, wherein center coordinates are calculated so that an area of the difference pattern is the minimum, centers of the two layout patterns are shifted to the center coordinates, and then a difference process is performed.

14. The defect inspection supporting method according to claim 11, wherein the weight values are set in accordance with a lithography simulation result of mask data of the layout patterns, a pattern line width, a pattern pitch, a mask dimension error sensitivity value, correction or non-correction of a pattern in manufacturing of a mask, a deviation amount from a dimension average value in in-plane measurement of the mask when the dimension of the mask is ensured, or a distance from the maximum exposure shot end.

15. The defect inspection supporting method according to claim 11, further comprising:
calculating a use frequency of the layout patterns belonging to the groups on design data,
wherein the rankings of the groups are calculated based on the numbers of layout patterns belonging to the groups, the use frequency of the layout patterns belonging to the groups, and the weight values of the groups.

16. The defect inspection supporting method according to claim 11, wherein the layout pattern is a layout pattern of a semiconductor integrated circuit.

17. The defect inspection supporting method according to claim 11, wherein the extracted layout pattern with the defect is a resist pattern transferred to a resist film on a wafer and a transfer pattern transferred to a processing layer on the wafer.

18. The defect inspection supporting method according to claim 17, wherein the layout pattern with the defect is a pattern in which a difference between a captured image of the resist pattern or the transfer pattern and the layout pattern on the design data exceeds a preset threshold value.

19. The defect inspection supporting method according to claim 11, wherein an extraction range of the layout pattern with the defect is set as a range delimited by a few μm in each side.

20. The defect inspection supporting method according to claim 11, wherein the formation difficulty is determined based on a lithography simulation result of mask data of the layout patterns, a minimum dimension of a design rule, a minimum pitch of the design rule, or sensitivity of wafer dimension irregularity with respect to mask dimension irregularity.
